(19) United States
(12) Patent Application Publication
(10) Pub. No.: US 2008/0293267 A1
(43) Pub. Date: Nov. 27, 2008

(54) ELECTRICAL CONNECTOR WITH STRESS-DISTRIBUTION FEATURES

(75) Inventors: Hung Viet Ngo, Harrisburg, PA (US); Timothy W. Houtz, Etters, PA (US)

Correspondence Address: WOODCOCK WASHBURN, LLP, CIRA CENTRE, 12TH FLOOR, 2929 ARCH STREET, PHILADELPHIA, PA, 19104-2891, US

(73) Assignee: FCI, Reno, NV (US)

(21) Appl. No.: 11/751,351

(22) Filed: May 21, 2007

(51) Int. Cl. H01R 12/00

(52) U.S. Cl. 439/75

(57) ABSTRACT

A connector capable of being mounted onto a substrate is disclosed. Such a connector may include a housing, and a contact mounted within the housing. The contact may include a body, terminal pins extending from a first edge of the body, contact beams extending from a second edge of the body, and a flared portion. The edges of a first contact beam and a second contact beam of the contact beams may be positioned proximate respective adjacent surfaces of the housing. The flared portion may also be positioned proximate a respective adjacent surface of the housing. The relationship between the first contact beam and its respective adjacent surface, the relationship between the second contact beam and its respective adjacent surface, and the relationship between the flared portion and its respective surface may inhibit bowing of the body of the contact when the connector is mounted on the substrate.

### FIELD OF THE INVENTION

Generally the invention relates to electrical connectors. More particularly the invention relates to power connectors.

### BACKGROUND OF THE INVENTION

A Power connector for transmitting electrical power may be mounted onto a printed circuit board (“PCB”) using a press fit. The press fit application of the connector may generate some concerns about the contact deformation and damage to the housing, especially on a vertical receptacle or header connector. More particularly, if a large enough gap exists between the contact beams of the contacts and the interior walls of the housing, the middle portions of the press-fit tails may arc or bow away from the PCB during mounting of the connector onto the PCB.

For example, FIGS. 1A and 1B depict the relationship between a contact 10 and a housing 14 of a prior art connector. As depicted, the contact 10 has a body 16 and a plurality of contact beams 18 extending from a first edge 20 of the body 16. When the contact 10 is mounted in the housing 14, a large gap 24 exists between an edge 28 of a first contact beam 32 of the plurality of contact beams 18 and an upper sidewall 36 of the housing 14. Further, when the contact 10 is mounted in the housing 14, a large gap 40 exists between an edge 44 of a second contact beam 48 of the plurality of contact beams 18 and a lower sidewall 52 of the housing 14. When the press pins (not shown) of the contact 10 are pressed into a substrate (not shown), the body 16 of the contact 10 may arc or bow. A middle point 56 of the body 16 may displace about 0.246 mm due to the arcing or bowing of the contact 10. FIG. 1C depicts a bowed or arced contact 10. Because the body 16 is bowed, the contact beams 18 spread apart causing different sized gaps 58 between adjacent contact beams 18. Accordingly, a need exists for features that reduce or eliminate such arcing or bowing of the body 16 may be desired.

### SUMMARY OF THE INVENTION

Disclosed herein is an electrical connector that may be capable of inhibiting bowing of the contacts of the connector when the connector is mounted on a substrate. Such a connector may include a housing and a contact mounted in the housing. The contact may include a body, a plurality of terminal pins extending from a first edge of the body and a plurality of contact beams extending from a second edge of the body. At least a portion of the edges of a first contact beam and of a second contact beam may be positioned proximate respective adjacent surfaces of the housing when the connector is not mounted on the substrate. Contact between the at least a portion of the edges of the first and second contact beams and their respective adjacent surfaces of the housing during mounting of the connector on the substrate may restrain the contact beams and may inhibit bowing of the body of the contact. The contact beams may be arranged in a substantially linear array and the first and second contact beams may be located at respective first and second ends of the substantially linear array.

In another embodiment of the connector, the body of the contact may include a flared portion. The flared portion may be positioned proximate an adjacent surface of the housing when the connector is not mounted on the substrate. Contact between the flared portion and the surface of the housing adjacent the flared portion during mounting of the connector on the substrate may inhibit bowing of the body of the contact.

### BRIEF DESCRIPTION OF THE DRAWINGS

FIG. 1A is a perspective view of a connector system depicting the relationship between a connector housing and a contact assembly found in the prior art.

FIG. 1B is a side view of the connector system of FIG. 1A.

FIG. 1C is a side view of the connector system of FIG. 1A depicting a bowed contact.

FIG. 2A is a front perspective view of an exemplary embodiment of a connector.

FIG. 2B is a back perspective view of the connector shown in FIG. 2A.

FIG. 3 is a perspective view of a contact.

FIG. 4 is a side view of a first half of a contact.

FIG. 5 is a partial bottom view of the first half of the contact of FIG. 4.

FIG. 6 is a perspective view of the first half of the contact of FIG. 4 positioned to combine with a second half of a contact.

FIG. 7 is a cut away view of an example embodiment of a connector depicting the relationship between a housing and the contact of FIG. 3.

FIG. 8 is a partial top view of the connector of claim 7 depicting the relationship between the flared portions of the contact of FIG. 3 and the housing.

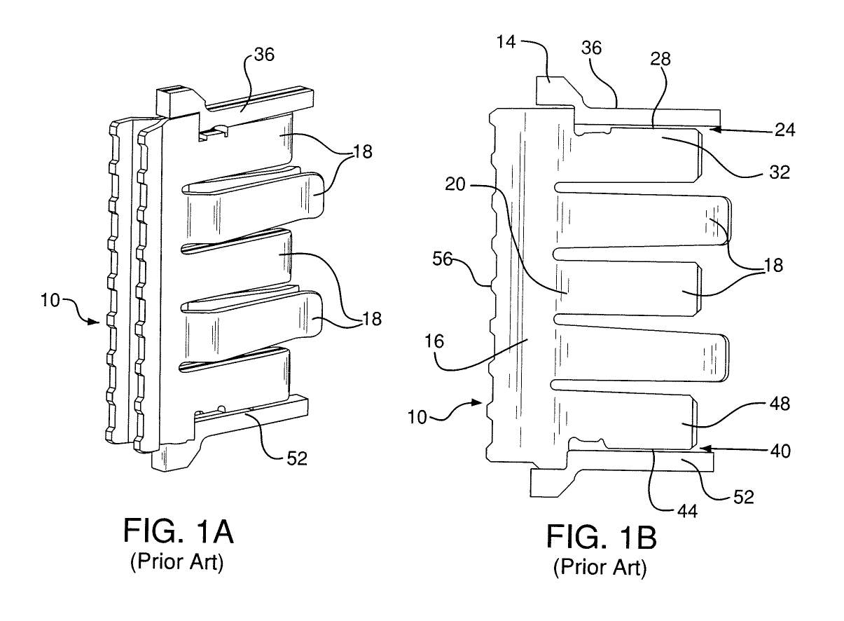

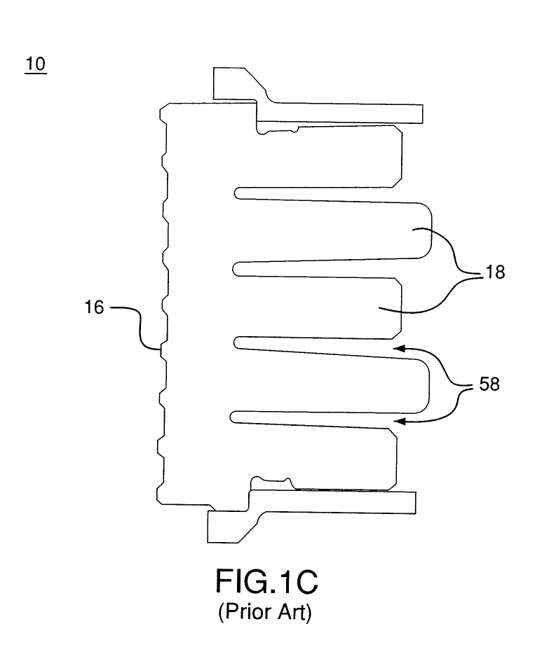

### DETAILED DESCRIPTION OF ILLUSTRATIVE EMBODIMENTS

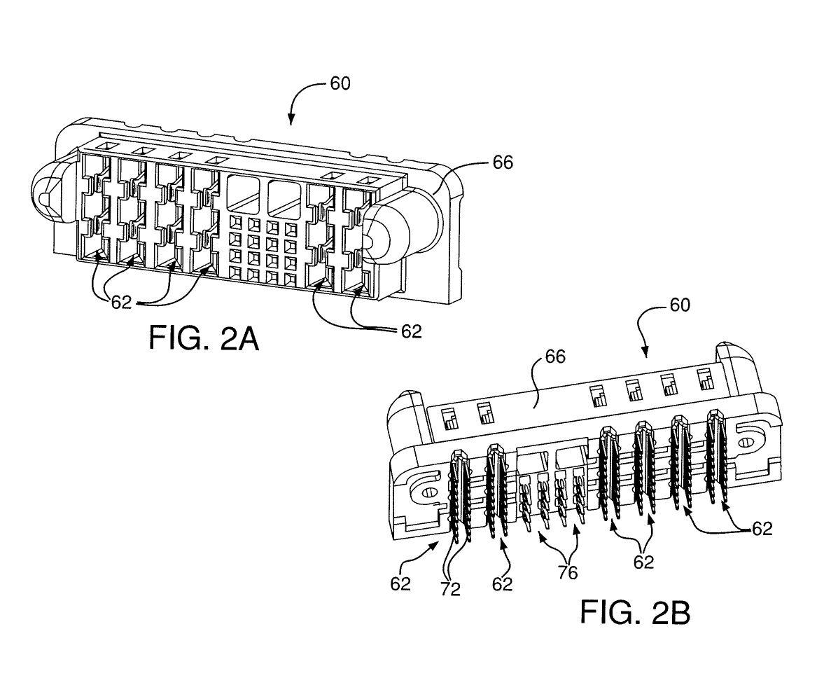

FIGS. 2A and 2B depict an example embodiment of a connector 60 having several contacts 62 mounted in a housing 66. As illustrated the contacts 62 may include several terminal pins 72. Additionally, the connector 60 may include an array of signal contacts 76 located between the contacts 62. When the terminal pins 72 are press fit onto a substrate, the connector 60 may inhibit bowing of the contacts 62. The particular configuration of connector 60 shown, is disclosed for exemplary purposes only. For example, while the connector 60 is depicted with six contacts 62, the connector 60 is not limited to such a number, and may include any number of contacts 60. Furthermore, while the particular connector 60 depicted is a vertical receptacle connector, the connector 60 is not limited to such an embodiment, and may include other configurations.

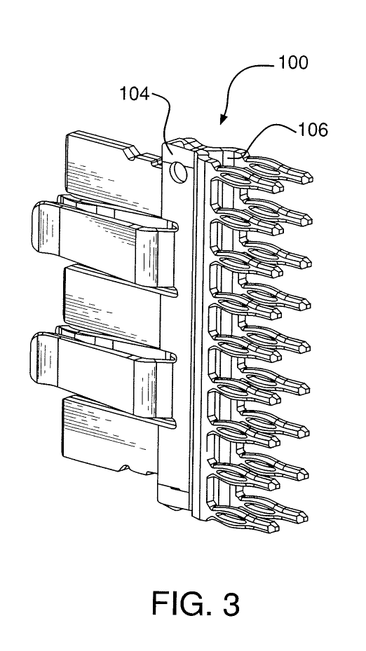

FIG. 3 depicts an example embodiment of a contact 100 capable of being mounted in a connector housing. The contact 100 may be made from an electrically conductive material, such as metal. The contact 100 may be a power contact. As depicted, the contact 100 may include a first half 104 and a second half 106. While the contact 100 is depicted as comprising two halves, the contact 100 is not limited to such a design and may be manufactured as a single unitary structure.

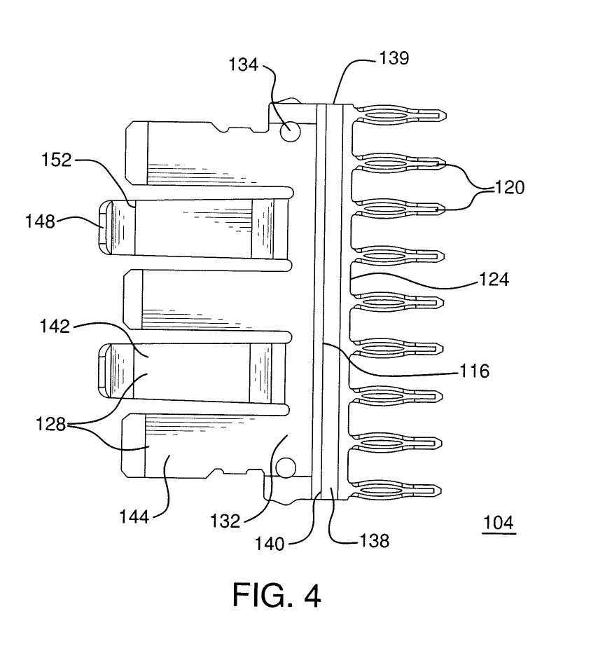

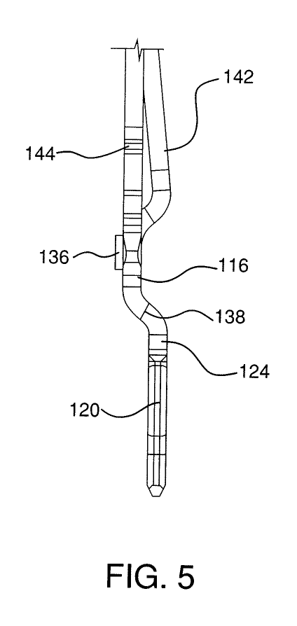

FIGS. 4 and 5 are more detailed views of the first half 104 of the contact 100. As depicted, the first half 104 may include a body 116, a plurality of terminal pins 120 extending from a first edge 124 of the body 116, and a plurality of contact beams 128 extending from a second edge 132 of the body 116.

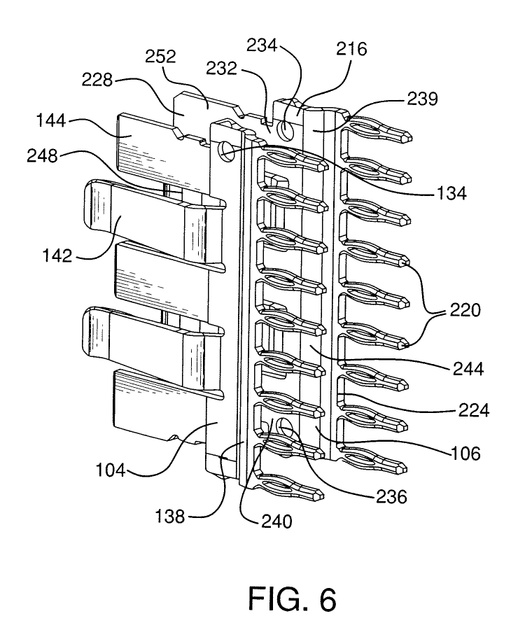

As depicted, the body 116 may include a thru hole 134, a dimple 136 and a flared portion 138. The thru hole 134 may be formed in a first end 139 of the body 116, and the dimple 136 may protrude from a second end 140 of the body 116. The first end 139 may be opposite to the second end 140. The function of the thru hole 134 and the dimple 136 is explained below in connection with FIG. 6.

The terminal pins 120 may be capable of being received by penetrations in a substrate (not shown). The terminal pins 120 may be eye-of-the-needle press-fit pins. As best shown in FIG. 5, the terminal pins 120 of the first half 104 may be offset by the flared portion 138. As depicted, the flared portion 138 of the first half 104 may flare out in a first direction from the body 116.

The contact beams 128 may each be designed to have a specific structure. For example, the first half 104 may include two angled contact beams 142 and three substantially straight contact beams 144. The angled contact beams 142 and the straight contact beams 144 may be arranged in a staggered or alternating manner, i.e. each angled contact beam 142 may be positioned adjacent to a straight contact beam 144. Furthermore, the angled contact beams 142 may include a flared portion 148 at a first end 152 of the contact beams 142. An example angle in which the angled beam 142 may be formed can be seen in FIG. 5. The first half 104 is not limited to five contact beams 128 as depicted, and may include any number of contact beams 128. Furthermore, the first half 104 is not limited to alternating angled beams 142 and straight beams 144. For example, the first half 104 may have all angled beams 142 or all straight beams 144.

FIG. 6 depicts the first half 104 and the second half 106 positioned to combine and form the contact 100. As depicted, the second half 106 may be identical to the first half 104 but may be rotated 180 degrees. Accordingly, like the first half 104, the second half 106 may have a body 216, a plurality of terminal pins 220 extending from a first edge 224 of the body 216, and a plurality of contact beams 228 extending from a second edge 232 of the body 216. In combination, the thru hole 134 of the first half 104 may receive a dimple 234 protruding from a first end 239 of the body 216 of the second half 106, and the dimple (not shown in FIG. 6) of the first half 104 may engage a thru hole 236 formed in a second end 240 of the body 216 of the second half 106.

The body 216 of the second half 106 may also include a flared portion 244. As depicted, the flared portion 244 may flare out from the body 216 of the second half 106. The flared portion 244 may flare out from the body 216 in a direction opposite of the flared portion 138 formed in the first half 104. That is, flared portion 244 may extend in one direction, while flared portion 138 may extend in the opposite direction.

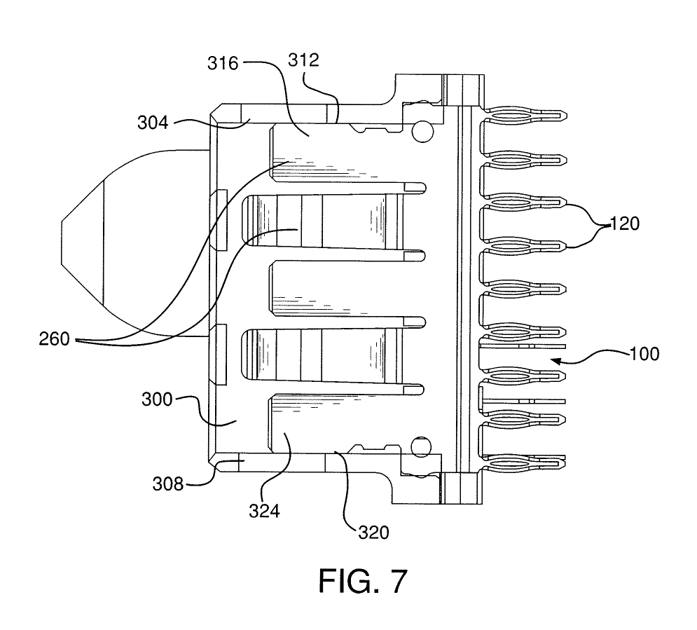

The contact beams 228 of the second half 106 may also include angled contact beams 248 and straight contact beams 252. When the first half 104 is combined with the second half 106, the angled beams 142 of the first half 104 may align with the angled beams 248 of the second half 106. Similarly, the straight beams 144 of the first half 104 may align with the straight beams 252 of the second half 106. When the first half 104 and the second half 106 are combined, the combination may form a plurality of contact beam pairs 260 as depicted in FIG. 7.

FIG. 7 depicts contact 100 mounted in a housing 300. The housing 300 may be made from a dielectric material such as a plastic for example. As depicted, the housing 300 may have a first sidewall 304 and a second sidewall 308. When the contact 100 is mounted in the housing 300, an edge 312 of a first contact beam 316 of the plurality of contact beam pairs 260 may be positioned proximate the first sidewall 304. Additionally, when the contact 100 is mounted in the housing 300, an edge 320 of a second contact beam 324 of the plurality of contact beam pairs 260 may be positioned proximate the second sidewall 308. As depicted, the edge 312 of the first contact beam 316, and the edge 320 of the second contact beam 324 may abut the first and second sidewalls 304, 308 of the housing 300. Alternatively, the edge 312 of the first contact beam 316, and the edge 320 of the second contact beam 324 may define a gap (not shown) with the respective first and second sidewalls 304, 308. The gap defined between the edge 312 of the first contact beam 316 and the first sidewall 304 and the gap defined between the edge 320 of the second contact beam 324 and the second sidewall 308 may be up to about 2 thousandths of an inch wide. Increasing the gap may increase the probability of bowing. Accordingly, there is preferably no gap.

The terminal pins 120, 220 of the contact 100 may be pressed into a substrate (not shown). During insertion of the terminal pins 120, 220 into the substrate the relationship (i.e. close proximity of) between the edge 312 of the first contact beam 316 and the first sidewall 304, and the relationship (i.e. close proximity of) between the edge 320 of the second contact beam 324 and the second sidewall 308 may help inhibit bowing or arcing of the contact 100. For example, the relationship may limit the deflection of the contact beam pairs 260 in directions substantially perpendicular to the direction in which the contact beam pairs 260 extend. Inhibiting the bowing of the contact 100 may not only limit the deflection of the contact beam pairs 260 but may also create a substantially uniform distribution of stress during press-fit of the terminal pins 120, 220 onto the substrate.

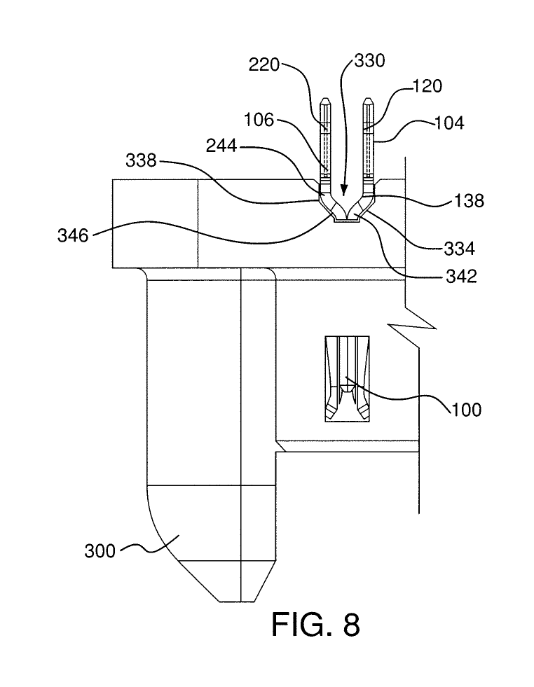

FIG. 8 depicts the relationship between the flared portions 138, 244 and the housing 300. As depicted the housing 300 may include an aperture 330 having a first side wall 334 and a second sidewall 338. When the contact 100 is mounted in the housing 300, an edge 342 of the flared portion 138 of the first half 104 may be positioned proximate the first sidewall 334 of the aperture 330. Additionally, when the contact 100 is mounted in the housing 300, an edge 346 of the flared portion 244 of the second half 106 may be positioned proximate the second sidewall 338 of the aperture 330. As depicted, the edge 342 of the flared portion 138, and the edge 346 of the flared portion 244 may abut the first and second sidewalls 334, 338 of the aperture 330. Alternatively, the edge 342 of the flared portion 138, and the edge 346 of the flared portion 244 may define a gap (not shown) with the respective first and second sidewalls 334, 338 of the aperture 330. The gap defined between the edge 342 of the flared portion 138 and the first sidewall 334 and the gap defined between the edge 346 of the flared portion 244 and the second sidewall 338 may be up to about 2 thousandths of an inch wide. Increasing the gap may increase the probability of bowing. Accordingly, there is preferably no gap.

During insertion of the terminal pins 120, 220 into the substrate, the relationship (i.e. close proximity of) between the edge 342 of the flared portion 138 and the first sidewall 334, and the relationship (i.e. close proximity of) between the edge 346 of the flared portion 244 and the second sidewall 338 may further help inhibit bowing or arcing of the contact 100. Inhibiting the bowing of the contact 100, as noted above, may limit the deflection of the contact beam pairs 260 and may create a substantially uniform distribution of stress during press-fit of the terminal pins 120, 220 onto the substrate.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

1. A connector capable of being mounted on a substrate, the connector comprising:
a housing defining a housing surface; and
a contact mounted in the housing, the contact comprising a body, a plurality of terminal pins extending from a first edge of the body and capable of being received by penetrations in the substrate, and a plurality of contact beams extending from a second edge of the body, wherein at least a portion of one of the contact beams is spaced from the housing surface by a gap of no more than 0.002 inch when the connector is not mounted on the substrate.

2. The connector of claim 21, wherein the contact beams are arranged in a substantially linear array and the first and second contact beams are located at respective first and second outer ends of the substantially linear array.

3. The connector of claim 21, wherein the at least a portion of the first and second contact beams abut the respective first and second housing surfaces when the connector is not mounted on the substrate.

4. (canceled)

5. The connector of claim 21, wherein the contact beams extend substantially from the body in a first direction, and die contact between the contact beams and the respective first and second housing surfaces limits deflection of the contact beams in directions substantially perpendicular to the first direction as the terminal pins are inserted into the penetrations in the substrate.

6. The connector of claim 1, wherein the body includes a flared portion that is spaced from an adjacent surface of the housing by a gap of no more than 0.002 inch when the connector is not mounted on the substrate.

7. The connector of claim 1, wherein the housing defines a vertical receptacle housing.

8. The connector of claim 1, wherein the connection between the contact and the housing creates a substantially uniform distribution of stress during press-fit of the connector onto the substrate.

9. The connector of claim 1, wherein the contact comprises a first half and a second half separable from the first half

10. A connector capable of being mounted on a substrate, the connector comprising:
a housing defining a housing surface; and
a contact mounted in the housing, the contact comprising a body, a plurality of terminal pins extending from a first edge of the body and capable of being received by penetrations in the substrate, and a plurality of contact beams extending from a second edge of the body, wherein the body includes a flared portion, the flared portion being spaced from the housing surface by a gap of no more than 0.002 inch when the connector is not mounted on the substrate.

11. The connector of claim 10, wherein the housing defines a vertical receptacle housing.

12. (canceled)

13. The connector of claim 10, wherein the flared portion abuts the respective adjacent surface of the housing when the connector is not mounted on the substrate.

14. The connector of claim 10, wherein the contact comprises a first half and a second half separable from the first half.

15. (canceled)

16. (canceled)

17. (canceled)

18. (canceled)

19. (canceled)

20. (canceled)

21. The connector of claim 1, wherein the housing surface is a first housing surface, and the housing further comprises a second housing surface, and the one of the contact beams is a first contact beam, and contact the further comprises a second contact beam, and at least a portion of the second contact beam is spaced from the second housing surface by a gap of no more than 0.002 inch before the connector is mounted on the substrate.

22. A method of restricting bowing in a connector configured for connection to a substrate, the method comprising the steps of:
providing a housing defining opposing first and housing surfaces; and
mounting a contact in the housing, wherein the contact includes a contact body having opposing first and second edges, a plurality of terminal pins extending from the first edge and capable of connection to the substrate, and a plurality of contact beams extending from the second edge, such that at first and second contact beams of the plurality of contact beams are spaced from the first and second housing surfaces, respectively, by a gap of no more than 0.002 inch.

23. The method as recited in claim 22, wherein the body includes a flared portion and the housing defines a third housing surface, and the positioning step further comprises spacing the flared portion from the third housing surface by a gap of no more than 0.002 inch.

24. The method as recited in claim 22, wherein the first and second contact beams abut the respective first and second housing surfaces.

25. A connector capable of being mounted on a substrate, the connector comprising:
a housing defining a housing surface; and
a contact mounted in the housing, the contact comprising a body, a plurality of terminal pins extending from a first edge of the body and capable of being received by penetrations in the substrate, and a plurality of contact beams extending from a second edge of the body,
wherein each terminal pin is configured to receive a substantially equal force as the connector is mounted onto the substrate.

26. The connector as recited in claim 25, wherein each body includes a flared portion that is spaced from an adjacent housing surface by a gap of no more than 0.002 inch when the connector is not mounted on the substrate.

27. The connector as recited in claim 26, wherein the flared portion abuts the adjacent housing surface when the connector is not mounted on the substrate.

28. The connector as recited in claim 25, wherein an outer pair of contact beams of the plurality of contact beams each is spaced from respective adjacent housing surfaces by a gap of no more than 0.002 inch when the connector is not mounted on the substrate.

29. The connector as recited in claim 28, wherein the outer pair of contact beams of the plurality of contact beams each abuts the respective adjacent housing surfaces when the connector is not mounted on the substrate.

30. A connector capable of being mounted on a substrate, the connector comprising:
a housing defining a housing surface; and
a contact mounted in the housing, the contact comprising a body, a plurality of terminal pins extending from a first edge of the body and capable of being received by penetrations in the substrate, and a plurality of contact beams extending from a second edge of the body,
wherein the terminal pins is configured to extend into the penetrations in the substrate at a substantially constant depth when the connector is mounted onto the substrate.

31. The connector as recited in claim 30, wherein each body includes a flared portion that is spaced from an adjacent housing surface by a gap of no more than 0.002 inch when the connector is not mounted on the substrate.

32. The connector as recited in claim 31, wherein the flared portion abuts the adjacent housing surface when the connector is not mounted on the substrate.

33. The connector as recited in claim 30, wherein an outer pair of contact beams of the plurality of contact beams each is spaced from respective adjacent housing surfaces by a gap of no more than 0.002 inch when the connector is not mounted on the substrate.

34. The connector as recited in claim 33, wherein the outer pair of contact beams of the plurality of contact beams each abuts the respective adjacent housing surfaces when the connector is not mounted on the substrate.
